(19) United States
(12) Patent Application Publication
(10) Pub. No.: US 2014/0290754 A1
(43) Pub. Date: Oct. 2, 2014

(54) Flameless Heating System

(71) Applicants: Rusty Lamb, Broussard, LA (US); James B. Crawford, Lafayette, LA (US); John Bibaeff, JR., Lafayette, LA (US)

(72) Inventors: Rusty Lamb, Broussard, LA (US); James B. Crawford, Lafayette, LA (US); John Bibaeff, JR., Lafayette, LA (US)

(21) Appl. No.: 14/285,292

(22) Filed: May 22, 2014

Related U.S. Application Data
(63) Continuation-in-part of application No. 13/199,465, filed on Aug. 31, 2011.
(60) Provisional application No. 61/378,627, filed on Aug. 31, 2010.

(51) Int. Cl. B08B 9/032; F16L 55/26; B08B 13/00

(52) U.S. Cl. CPC B08B 9/0322; B08B 13/00; F16L 55/26
USPC 137/238; 137/340; 137/242

(57) ABSTRACT

A system for flameless heating, wherein the system includes a modular flameless heating unit located on a singular skid. The modular flameless heating unit includes an internal combustion engine, a dynamic heat generator operatively connected to the internal combustion engine. Further, the system includes a pump being responsive to the operation of the internal combustion engine, whereby the pump is configured to provide a discharged fluid to the dynamic heat generator. Further still, the system includes a process outlet transfers the heat into a wellbore in order to affect removability of one or more deposits disposed within the wellbore.

### CROSS-REFERENCE TO RELATED APPLICATIONS

This application is a continuation-in-part of and claims priority to U.S. Non-Provisional Patent Application Ser. No. 13/199,465, filed on Aug. 31, 2011, which claims priority to U.S. Provisional Patent Application Ser. No. 61/378,627, filed on Aug. 31, 2010, wherein the entireties of both applications are incorporated herein by this reference for all purposes.

### BACKGROUND OF DISCLOSURE

1. Field of the Disclosure

Embodiments disclosed herein generally relate to the transferring, heating, and pumping of fluids. Specific embodiments are directed to a flameless heating system and process. Other embodiments pertain to a modular skid-mounted unit capable of pumping, heating, and transferring fluids, which includes a dynamic heat generator driven by a motor.

2. Background Art

A characteristic common to hydrocarbon production operations throughout the world is the eventual build-up of a wax or paraffin component of the hydrocarbons that deposits on the walls of wellbores and equipment, especially subsea portions, and solidifies at low temperatures. Some of these waxes or paraffins deposit and/or solidify at temperatures in excess of 100 degrees Fahrenheit, which means the deposits will form on wellbore and equipment surfaces even at temperatures close to ambient temperature. Once deposits form, the thickness of the deposit layer will increase over time, which causes, for example, increased pressure drop and/or decrease in desired flow rate within the wellbore.

Several known methods intended to deal with the negative effects of deposit build up include the use of chemicals and hot water injection, which subsequently return the deposits back into solution. However, prior art methods are limited in what they provide. For example, the use of chemicals requires a chemical storage facility, as well the ability to inject the chemicals into the system at high pressures. The use of chemicals is cost-prohibitive not only because of the large capital and equipment costs, but also the continual operating costs associated with the maintenance and handling of hazardous chemicals. It is further necessary for expensive separation processes in order to subsequently remove the chemicals from any produced hydrocarbons, such that the use of chemicals is not practicable.

In order to use heated fluids, it is generally necessary to have a heating source with an open flame, such as a gas fired heater, a furnace, etc. However, gas fired sources and the like suffer from high maintenance, noise pollution, short life spans, disproportionate fuel consumption, and fire hazards. Even more problematic is that there are many instances today where the use of an open flame is not desirous or is prohibited, such as in the oilfield industry. Thus, some prior art methods are directed to flameless systems in order to overcome the deficiencies, such as the use of steam generation.

In order to create steam, it is necessary to build a generation plant, typically designed to use production gases, and eventually inject steam into a producing formation. While there may not be an open flame in the vicinity of the producing formation, a flame may still be used, such as to ignite and burn the gases. In addition, there are large capital costs associated with building the plant, such that steam generation is only viable when there is an overabundance of gases available for burning. Because of the logistics and/or distances, there is often pressure drop associated with line losses that results in condensation. Condensed steam requires injection of liquid instead of vapor, thereby raising injection costs, and also results in a loss of heat.

Alternatively, some fluids are heated with systems that include electrical devices. However, the use of these devices is even more problematic because electrical devices are prone to arcing and/or sparking that result in destructive blasts or ignition of flammable vapors.

Accordingly, there exists a need for a modularized single-unit skid configured for on-site location to provide a flameless heating source that does not require an open flame, chemicals, or electrical devices. There also exists a need for a flameless heating system that may supply high-pressure heated fluids directly into wellbores. Other needs require a self-contained modularized unit that may provide heated fluids without the use of a flame so that the unit may be used in remote or otherwise hazardous oil and gas environments.

### SUMMARY OF DISCLOSURE

Embodiments may include a system for flameless heating, wherein the system includes a modular flameless heating unit located on a singular skid. The modular flameless heating unit includes an internal combustion engine, a dynamic heat generator operatively connected to the internal combustion engine. Further, the system includes a pump being responsive to the operation of the internal combustion engine, whereby the pump is configured to provide a discharged fluid to the dynamic heat generator. Further still, the system includes a process outlet transfers the heat into a wellbore in order to affect removability of one or more deposits disposed within the wellbore.

Another embodiment disclosed herein may provide a flameless heating process usable for treating fouled wellbores. The process may include the steps of receiving a process fluid into a modular flameless heating unit located on a singular skid. The modular flameless heating unit may include an internal combustion engine, a dynamic heat generator operatively connected to the internal combustion engine, and a pump configured to provide a discharged fluid to the dynamic heat generator. Further steps of the process may include heating the process fluid, with the operation of the dynamic heat generator of the modular flameless heating unit located on a singular skid, to a predetermined temperature that affects the removability of the deposits within the wellbore, outletting the process fluid from the flameless heating unit to a desired location.

Other aspects and advantages of the disclosure will be apparent from the following description and the appended claims.

### BRIEF DESCRIPTION OF DRAWINGS

FIG. 1 shows process flow diagram of a flameless heating system, in accordance with embodiments of the present disclosure.

FIG. 2 shows a process flow diagram of a flameless heating system, in accordance with embodiments of the present disclosure.

FIGS. 3A, 3B, 3C, 3D, and 3E show an isometric view and multiple side views, respectively, of a modular flameless heating unit, in accordance with embodiments of the present disclosure.

FIG. 4 shows a process flow diagram of a flameless heating system configured with a process control scheme, in accordance with embodiments of the present disclosure.

### DETAILED DESCRIPTION

Specific embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the disclosure. However, it will be apparent to one of ordinary skill in the art that the embodiments disclosed herein may be practiced without these specific details. In other instances, well-known features have not been described in detail to avoid unnecessarily complicating the description.

In addition, directional terms, such as “above,” “below,” “upper,” “lower,” “front,” “back,” etc., are used for convenience in referring to the accompanying drawings. In general, “above,” “upper,” “upward,” and similar terms refer to a direction toward the earth's surface from below the surface along a wellbore, and “below,” “lower,” “downward,” and similar terms refer to a direction away from the surface along the wellbore (i.e., into the wellbore), but is meant for illustrative purposes only, and the terms are not meant to limit the disclosure.

Embodiments disclosed herein may provide an apparatus, system, and process for the transferring, heating, and pumping of fluids. In an embodiment, a flameless heating apparatus may include a single skid-mounted unit. As such, the flameless heating apparatus may be a single unit that permits the transfer, heating, pumping of fluids. Further, the apparatus may be a highly efficient modular unit configured to heat and transfer process fluid, which may include without limitation, oil, diesel, water, or combinations thereof.

There are a number of applications whereby embodiments of the present disclosure may be beneficially used. For example, one application is assisting in removing stuck items in wellbores and equipment, where the sticking is a result of paraffin buildup or hydrate plugs. Other applications include washing out paraffin from subsea equipment or cleaning deepwater materials. In addition, embodiments may be used for the treatment of heavy crude or other process fluids before pumping the fluids through transfer lines, as well as cleaning oil storage vessels when paraffin builds up on bottom of holding tanks.

By way of example, the following applications are discussed below.

Wellbore Cleanouts

The modular unit may be used to feed high pressure, heated fluids to dissolve wax plugs, hydrates, asphaltenes, etc., which may have accumulated or otherwise deposited within the wellbore. Conventional methods to clean wellbore with coiled tubing use expensive chemical compositions to dissolve plugs and other obstructions. Use of embodiments disclosed herein advantageously reduce or eliminate chemical costs by delivering hot oil, hot diesel, or other heated fluids in place of such expensive chemicals.

Flowline Cleanouts with Wire Wash Tool

In some embodiments, systems and methods disclosed herein may be used with a free running pig for improved cleaning of wellbores (e.g., flow lines, transfer lines, etc.). For example, the system may include the provision of heated fluids to high-pressure pump inlets, as well as the use of braided line through flow lines with a wire wash tool or other similar equipment. The method and apparatus of the present invention provides the ability to clean out partially plugged wellbores and equipment by use of the tool or pig in conjunction with flamelessly heated fluids. As such, production may be dramatically increased by the removal of obstructions and the increase of flow area within the wellbore or subsea equipment. Beneficially, embodiments disclosed herein may remove such obstructions without the need to use or pump in large amounts of expensive chemicals.

Circulating Risers

Other embodiments may include the use of flameless heated fluids within a riser. For example, during maintenance and other down periods on deep-water oil and gas wells, risers sometimes plug up or become obstructed without flow. Such risers may be very expensive to unplug or clean. Currently, expensive electric heating devices are used to heat such risers during prolonged periods with no flow. However, systems and methods of the present disclosure may be used to circulate heated fluids within a riser until maintenance is completed or flow can be re-established in such riser, and whereby there is no electrical requirement.

Heating Frac Fluids

Currently, direct fire hot oil units heat fracking fluid in enclosed tank(s) until sufficiently hot, and then such fluids are placed in large tanks prior to injection down hole. Embodiments disclosed herein may be used to heat fracking fluids, including fluids maintained in multiple tanks, until such fracking fluids reach desired temperature, thereby saving rig time and speeding up fracking operations.

Heavy Crude Treatments

In certain areas around the world crude oil viscosity makes such crude too thick to flow. Embodiments disclosed herein may be used to heat such crude, and potentially add thinning solutions, until light enough to pump down lines.

Oil Tankers

When oil in oil tankers cool, the bottoms of such tankers may have several layers of wax or other materials deposited on the bottom of such tankers. Conventional methods involve cutting hole(s) in the holding tanks and shoveling out such wax and/or other deposits, and sometimes scraping same with heavy machinery. Advantageously, embodiments disclosed herein may be used to circulate heated fluids within or in association with the oil until the wax melts, whereby the melted wax and/or other liquids may be pumped out of a tanker.

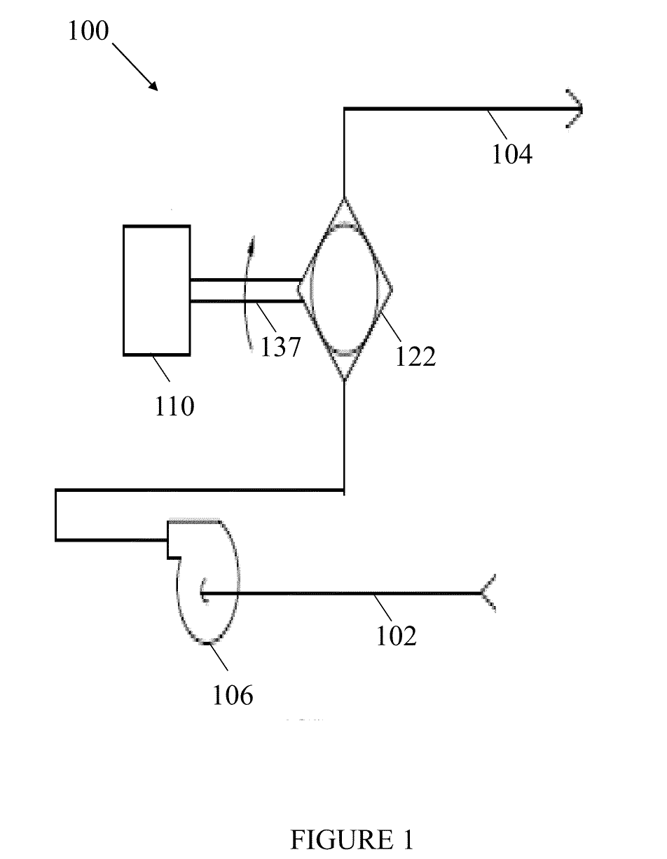

Referring now to FIG. 1, a process flow diagram of a flameless heating system 100 according to embodiments of the present disclosure, is shown. The flameless heating system 100 may include a number of components configured together for the heating and transferring of fluids therethrough. The system 100 may include an inlet flow line 102 coupled to an inlet pump 106. The pump 106 may be sized and configured accordingly to provide sufficient motive and driver for fluid discharged from the pump 106, whereby the fluid may adequately and/or completely flow from the system inlet 102 to a system outlet 104, and the head of the fluid may be sufficient to overcome any losses incurred from the system 100.

Process fluids may be heated by entering into a dynamic heat generator (DHG) 122. In an embodiment, process fluids may enter into the DHG 122 and may be subsequently heated. As such, the DHG 122 may be driven by the engine 110 that is connected to the pump 106.

The engine 110 may be, for example, a diesel engine, an internal combustion engine, a turbine, a hydraulic motor, etc., and may include a motor. In an embodiment, the power used to power the system 100 may be from the operation of the engine 110. By way of example, engine 110 may be a seventy-five horsepower diesel engine operatively configured for use in the system 100. FIG. 1 illustrates the coupling between an output shaft 137 of the engine's 110 motor and the DHG 122, such that rotational energy from the engine's 110 motor may be transferred, mechanically or otherwise, to the DHG 122. Although not shown, the engine 110 may be configured to provide additional rotary motion to a plurality of pumps coupled with the engine 110.

Thus, system 100 may include the engine's 110 motor used to drive and/or rotate the DHG 122 and/or any subcomponents associated therewith. Accordingly and advantageously, the DHG 122 may be driven by engine motor 114 in order to heat the fluids to a predetermined temperature without the need for a flame. The change in temperature between process fluids that enter and then exit the DHG 122 may be controlled, for example, by variation of process flow rates, modifications of the DHG 122 surface area, etc. The change in temperature may affect the removability by making it easier to remove one or more deposits on account of the temperature chemically altering and/or inducing phase change(s) in the one or more deposits within the wellbore.

In some embodiments, the resultant temperature of the heated process fluid that exits the DHG 122 may be in the range of 200-300 degrees Fahrenheit. In other embodiments, the resultant temperature of the heated fluid may be in the range of 300-500 degrees Fahrenheit. In a particular embodiment, the resultant temperature of the heated fluid may be in the range of temperature(s) required to melt paraffins formed on inner surfaces of wellbores and equipment, including those subsea and subterranean.

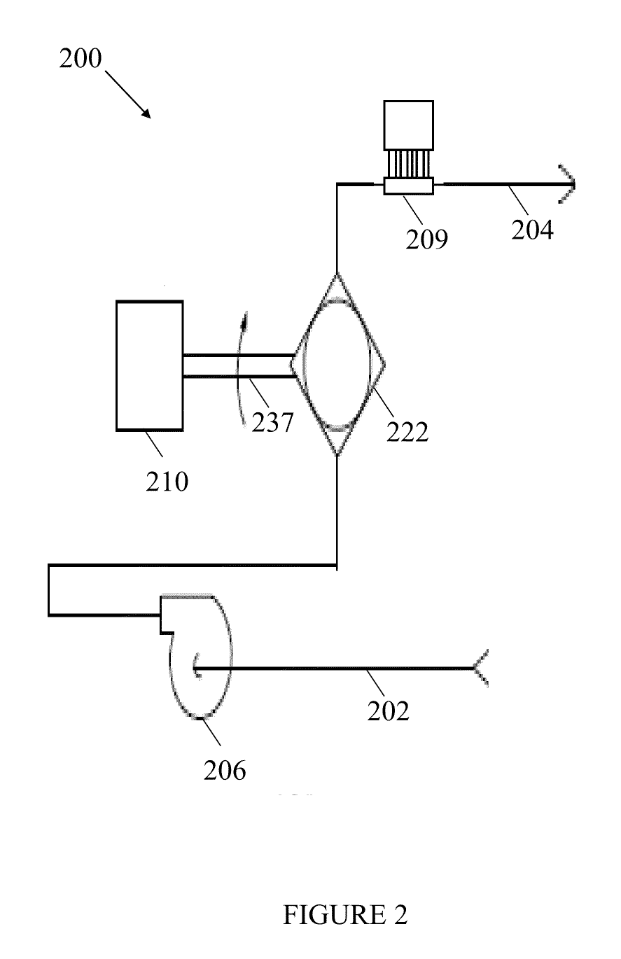

Referring now to FIG. 2A, a process flow diagram of a flameless heating system 200 according to embodiments of the present disclosure, is shown. Like the system 100 previously described, the flameless heating system 200 may be a modularized system used to pump, transfer, and heat fluids without the use of an open flame. The system 200 may include similar components, unit operations, and materials of construction as described for system 100, however, the systems need not necessarily be identical.

As shown, the system 200 may include an inlet flow line 202 coupled to an inlet pump 206. Pump 206 may be sized and configured accordingly to provide sufficient motive and driver for fluid to flow through the system 200 between the inlet 202 and a system outlet 204, such that the head of the fluid is sufficient to overcome any losses incurred as a result of the transfer of the fluid through the system 200.

The inlet pump 206 may be, for example, a low-pressure pump. In operation, pump 206 may be configured to function within operational parameters such as 5,000-12,000 gpm, approximately 500-600 horsepower, and may produce a pressurized discharge flow in a range of about 4 bars. In other embodiments, the flow rate may be in the range of 15,000-25,000 gpm.

As a result of frictional losses, velocity head, etc., the pressure of the process fluid transferred through the system 200 may be reduced. As such, a booster pump 209 may be used to boost the pressure, such that the system 200 may thus include the booster pump 209 coupled with the system outlet 204. In some embodiments, the booster pump 209 may be a high-pressure pump. High-pressure pumps may be operated at lower pressures, and, as such, the booster pump 209 may be operated accordingly in order to transport heated fluids out of the system 200. Advantageously, booster pump 209 may be able to deliver high pressure pumping when needed, as well as a low pressure pumping as appropriate. In this way, optimum pumping may be available at all times during operation of the system 200. A high-pressure pump(s) suitable for use with system 200 are commercially available.

In operations when high pressure pumping is used or desired, the normal operating pressure provided by the booster pump 209 may be a fluid pressure of at least 10 bars. In some embodiments, the booster pump 209 may be used to boost the pressure to a pressure range of about 100-200 bars. At other times during operation when high pressure is unnecessary, the booster pump 209 may be configured or operated to provide a fluid pressure in the range of about 1 to 5 bars.

While a single high pressure pump may be quite sufficient to transport the heated process fluids through wellbores, etc., one or more auxiliary pumps (not shown) may also be provided so as to extend the distance pumped or to further increase the pressure.

The inlet pump 206 is connected to a dynamic heat generator (DHG) 222. For example, the DHG 222 may receive a process fluid that is pumped 206 through the inlet flow.

The engine 210 may be, for example, a diesel engine, an internal combustion engine, a turbine, a hydraulic motor, etc. By way of illustration, the engine 210 may be a one hundred horsepower diesel engine. In an embodiment, the power source for the system 200 may be the engine 210, which may also further include a motor operatively connected therewith. The motor may further include an operative connection with an output rotational shaft 237 that may be also coupled with the DHG 222.

Referring now to FIG. 2, a view of interconnectivity between an output shaft 237 and a DHG 222 is shown. Although not meant to be limited, the operative connection between the shaft 237 and the DHG 222 may be by mechanical linkage, such as mesh gears, worm gears, etc.

The DHG 222 may include various components, such as one or more rotatable internal members. Running the motor, and hence shaft 237 at a designated speed, such as in the range of 5000 RPMs, may cause the member to rotate, whereby various structures or protrusions disposed on the member may also rotate. The rotational motion of the member may cause compression of molecules associated with the process fluid, which subsequently may generate friction and heat that transfers to the fluid and raises the temperature of the fluid.

The DHG 222 may include the member with protrusions associated with a fixed body that may include corresponding protrusions. In operation, fluid may enter the DHG at an inlet. As the member rotates, fluid in contact with the protrusions may be subjected to outer and/or centrifugal forces. In addition, the fluid within the DHG 222 may incur a pressure increase that results in continuous motion of the fluid along the protrusions that may consequently cause additional kinetic energy or heat within the fluid.

Referring again to FIG. 2A, the heated fluid may exit from the DHG 222 via an outlet, and the fluid may exit the system 200 by transfer with the pump 209. The flow of fluid that exits the system 200 may be controlled via a process control system (not shown). In some embodiments, by controlling the process fluid flow and the power provided to the DHG 222, the process fluid that flows through the system 200 may be heated to any suitable temperature, as desired.

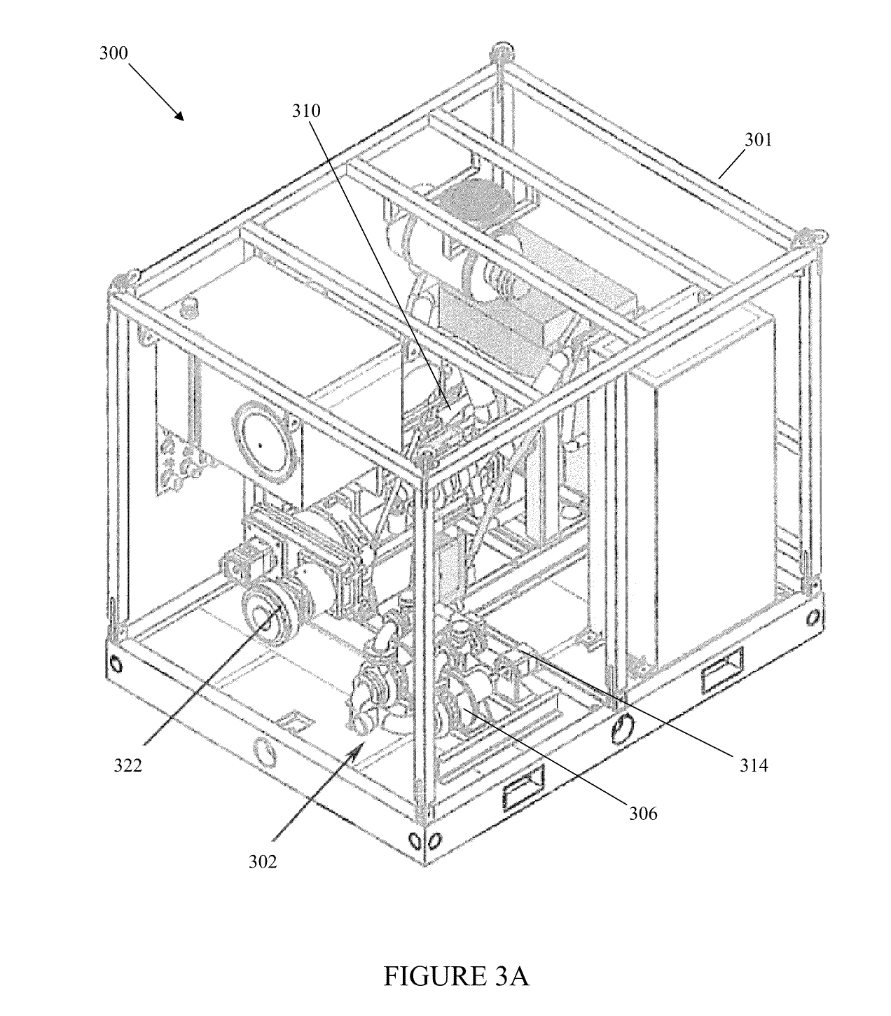

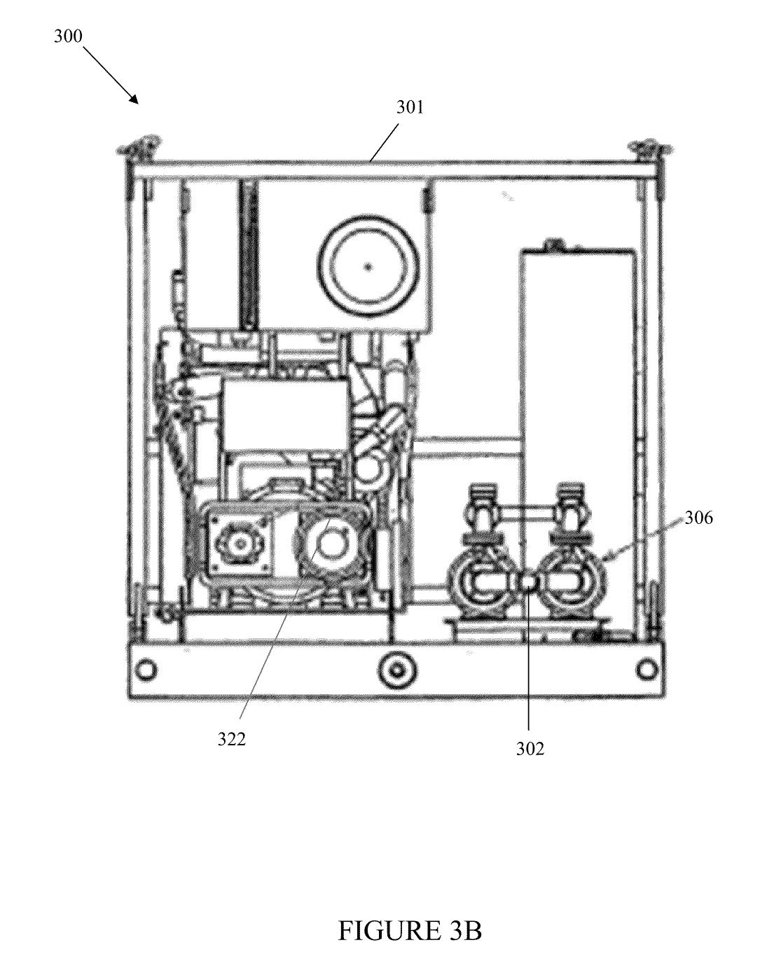

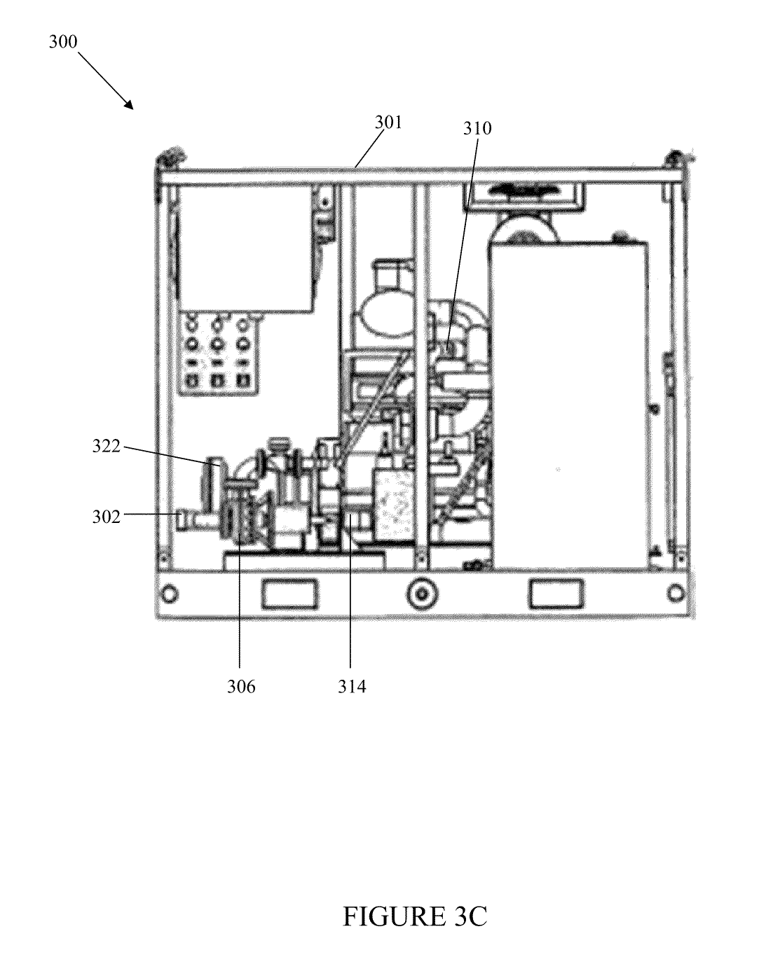

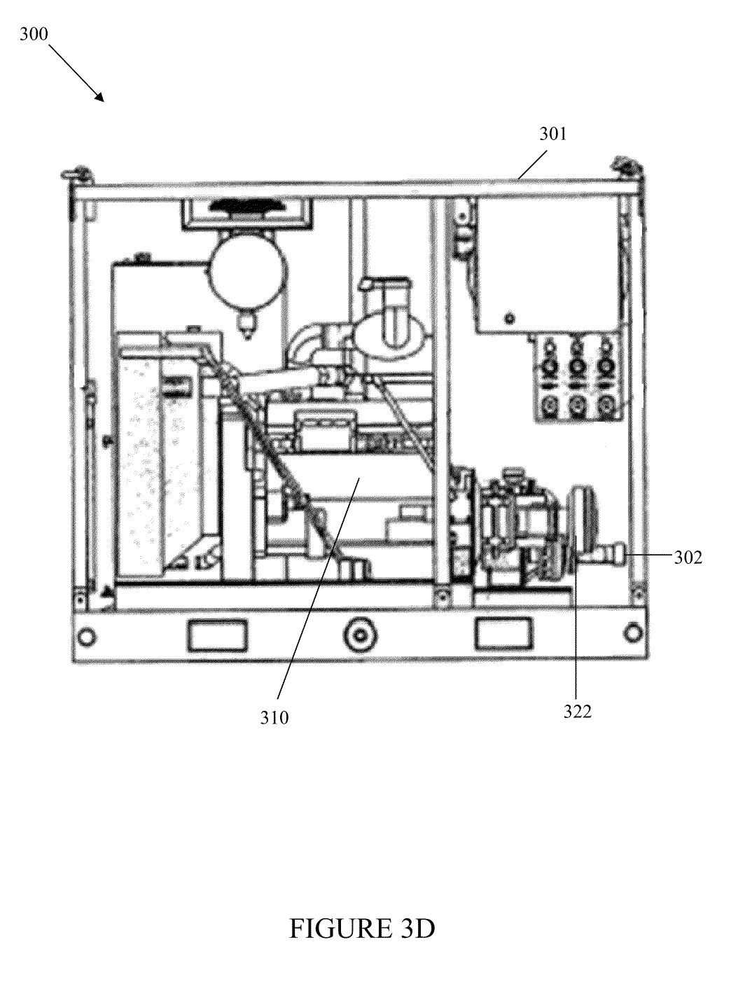

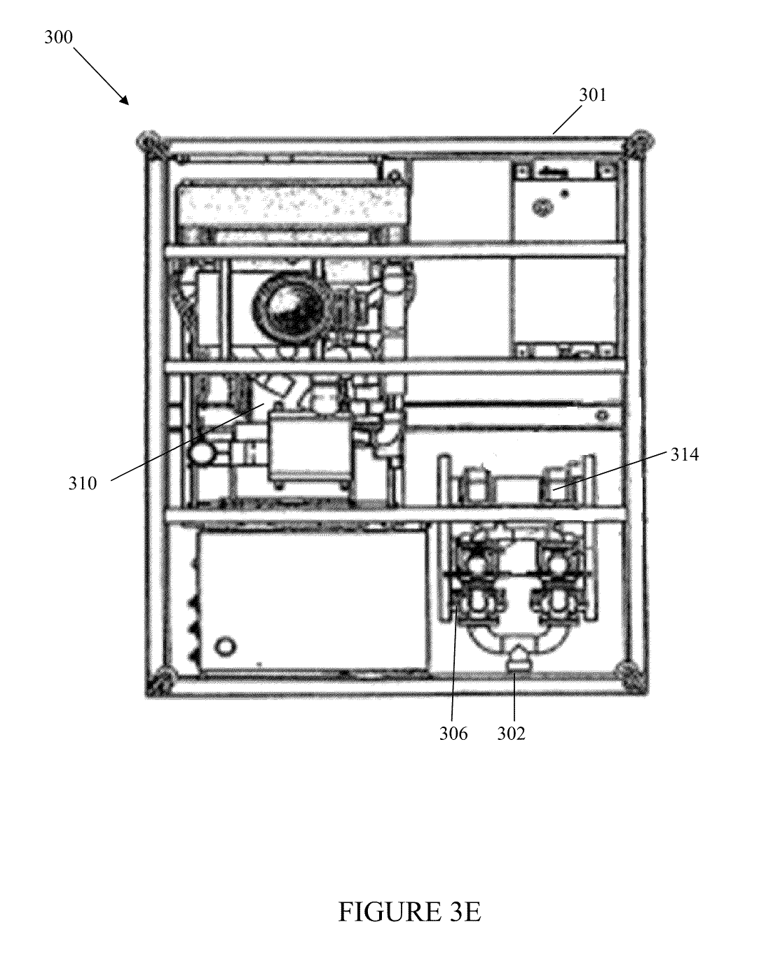

Referring now to FIGS. 3A-3E, an isometric view and multiple sideway perspective views, respectively, of a modularized flameless heating unit 300 in accordance with embodiments disclosed herein, are shown. Beneficially, components and subcomponents of flameless heating systems previously described may be configured with new and useful embodiments disclosed herein that provide a portable, modularized unit 300, such as one located on a single skid. As such, the unit 300 may include similar components, unit operations, and materials of construction as previously described for systems 100 and 200; however, they are not necessarily identical.

In operation, a process fluid may be pumped or otherwise transferred into the modular unit 300, whereby the temperature of the fluid may be raised as a result of hydrodynamic action imparted thereon. The modular unit 300 may include a frame 301, and a dynamic heat generator (DHG) 322 disposed within the frame 301. The DHG 322 may be operatively engaged with an assembly that may include an engine 310 and motor 314, whereby the engine 310 and the motor 314 are also disposed within the frame 301. The motor 314 may be used to operate the DHG 322 in order to heat the temperature of a fluid to a predetermined temperature without the necessity of a flame while doing so.

The difference in temperature between the process fluid that enters the DHG 522 and the subsequently heated process fluid that exits the DHG 322 may be controlled, for example, by adjusting process flow rates. Thus, at one point in the sequence of the operation of unit 300 the exit temperature may be about 400 degrees Fahrenheit. If the flow rate of the process fluid is increased, the temperature of the exit fluid may as a consequence be reduced.

Although not limited by any scale depicted or described, in some embodiments, the DHG 322 may be approximately two feet in diameter and one foot in width. In some embodiments, the DHG 322 and any of its associated components may be made from a durable material, such as steel or aluminum. However, the materials of construction are not meant to be limited, and hence the DHG 322 may just as well be constructed from other materials in other embodiments.

In particular embodiments, the DHG 322 may be similar or identical to an Island City, LLC dynamic heat generator. In operation, the motor 314 may run in a range of 1500-4500 RPMs.

The DHG 322 essentially acts as a device that uses the rotational energy generated by the motor 314, whereby process fluid that flows through the DHG 322 may include a relatively low velocity near its center and a high velocity at its outer diameter such that kinetic energy (heat) may be created or caused in the fluid. The result is the fluid flowing at a maximum velocity and the creation of kinetic energy (heat).

The ability of the DHG to utilize power created by the engine 310 may be understood with an understanding of basic principles of engineering, such as pump power laws. For example, power capacity is proportional to the input speed to the third power, and power capacity is proportional to the rotors diameter to the fifth power.

The modular unit 300 may be completely self-contained, and may be further sized and configured for quick installation. While installation of the unit 300 may be permanent, the single skid unit 300 may just as well be portable, including a quick-connect coupling system.

The modular unit 300 may include the engine 310, the motor 314, and a pump 306. In an embodiment, the pump 406 may be connected to a drive shaft (not shown) associated with the engine 310. The pump 306 may be coupled with a fluid inlet 302, and the fluid inlet 302 may be further associated or connected with a fluid source (not shown) located external of the unit 300.

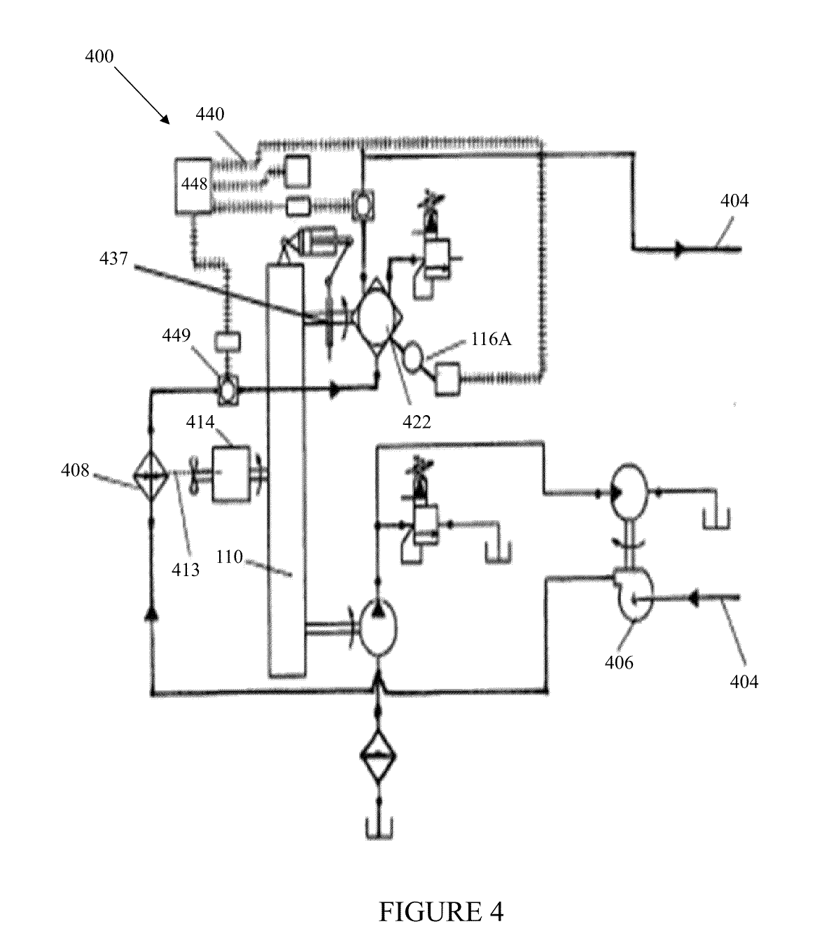

Referring now to FIG. 4, a process flow diagram of a flameless heating system 500 configured with a process control scheme 448 according to embodiments of the present disclosure, is shown. Although process control scheme 448 may be described with respect to system 400, the process control scheme 448 may be used with any of the systems, units, methods, etc. described herein.

Accordingly, the system 400 may include similar components, unit operations, and materials of construction as described for systems 100, 200, and 300, however, the systems are not necessarily identical. It may readily understood from FIG. 4 that conventional instrumentation for process measurement, control and safety may be usable with system 400. An operator interface or panel (315, FIG. 3B) may be configured to operate and monitor all of the functions of system 400, including operation of a dynamic heat generator 422.

The process control scheme 448 may further include, without any limitation, various sensors (e.g., temperature, pressure, flow, etc.) or other monitoring type devices, overpressure relief devices, regulators, and valves. Moreover, the process control for system 400 is not limited to any one particular scheme or configuration; instead, process control may be utilized any manner that would be understood to one of ordinary skill in the art.

Embodiments disclosed herein advantageously provide a modularized system that requires no electrical connections or electrical power. The modularization of a flameless heating unit may beneficially provide the ability for portability and/or usage in remote areas. The ability to provide heated fluids without the use of an open flame is highly advantageous for areas that are otherwise hazardous to open flames, such as oil and gas production sites. Embodiments disclosed herein are particularly beneficial for melting paraffin or other deposits formed in wellbores and equipment, whether above or below the sea.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A modular flameless heating unit located on a singular skid, the modular flameless heating unit comprising:
an internal combustion engine;
a dynamic heat generator operatively connected to the internal combustion engine;
a pump being responsive to the operation of the internal combustion engine, whereby the pump is configured to provide a discharged fluid to the dynamic heat generator; and
wherein a process outlet transfers the heat into a wellbore in order to affect removability of one or more deposits disposed within the wellbore.

2. The flameless heating unit of claim 1, wherein the heater is configured to cross-exchange with the discharged fluid before the discharged fluid enters the dynamic heat generator.

3. The flameless heating unit of claim 1, wherein the heater is configured to cross-exchange with a heated fluid stream produced by the dynamic heat generator.

4. The flameless heating unit of claim 1, further comprising a process control system for providing automation to the unit.

5. The flameless heating unit of claim 4, further comprising a control and monitoring system associated with the process control system.

6. The flameless heating unit of claim 1, further comprising more than one pump operatively connected to the internal combustion engine.

7. The flameless heating unit of claim 6, wherein the more than one pump increases the pressure of the process fluid to a range of 200-300 bar.

8. The flameless heating unit of claim 1, further comprising a tool operatively connected to the flameless heating unit for clearing at least a portion of the one or more deposits.

9. The flameless heating unit of claim 8, wherein the tool comprises a pig.

10. The flameless heating unit of claim 8, wherein the tool is run into the wellbore by wireline operations.

11. The flameless heating unit of claim 1, wherein the one or more deposits are selected from a group consisting of wax, paraffins, asphaltenes, and combinations thereof.
